(19) United States
(12) Patent Application Publication
(10) Pub. No.: US 2022/0320500 A1
(43) Pub. Date: Oct. 6, 2022

(54) ELECTROCHEMICAL DEVICE AND AN ELECTRONIC DEVICE

(71) Applicant: Ningde Amperex Technology Limited, Ningde City (CN)

(72) Inventor: Ao Liu, Ningde City (CN)

(73) Assignee: Ningde Amperex Technology Limited, Ningde City (CN)

(21) Appl. No.: 17/705,620

(22) Filed: Mar. 28, 2022

(30) Foreign Application Priority Data
Mar. 29, 2021 (CN) 202110335867.2

(51) Int. Cl. H01M 4/36; H01M 4/58

(52) U.S. Cl. CPC H01M 4/366; H01M 4/5825; H01M 2004/028

(57) ABSTRACT

A positive electrode includes a positive electrode current collector, a first active material layer, and a second active material layer. The second active material layer is located between the first active material layer and the positive electrode current collector. The first active material layer includes a first positive electrode material and a first lithium-containing material. The second active material layer includes a second positive electrode material. Each of a charge cutoff voltage of the first positive electrode material and a charge cutoff voltage of the second positive electrode material is greater than a gas production potential of the first lithium-containing material. A gas production rate per unit mass of the first active material layer is greater than a gas production rate per unit mass of the second active material layer.

### CROSS-REFERENCE TO RELATED APPLICATION

This application claims priority to the Chinese Patent Application Ser. No. 202110335867.2, filed on Mar. 29, 2021, the content of which is incorporated herein by reference in their entirety.

### TECHNICAL FIELD

The present application relates to the field of electrochemical technologies, and particularly, to an electrochemical device, an electrode, and an electronic device.

### BACKGROUND

In recent years, with the rapid development of electronic products and electric vehicles, the requirements for electrochemical devices (e.g., lithium ion batteries) is also increasing. The electrochemical device consumes part of the active lithium during the first cycle of charging and discharging, leading to a decrease in the energy density of the electrochemical device. In prior art, the initial efficiency is improved by pre-supplementing lithium to further increase the energy density. For example, a lithium-supplementing material is added to a positive electrode slurry. Although the current process can solve the above-mentioned problems to a certain extent, the lithium-supplementing material in the positive electrode active material layer produces gas near the positive electrode current collector during formation, which will cause a decrease in the cohesive force between the positive electrode active material layer and the positive electrode current collector. Therefore, a further improvement is desirable.

### SUMMARY

An embodiment of the present application provides an electrochemical device comprising:

a positive electrode, a negative electrode and a separator, and the separator is positioned between the positive electrode and the negative electrode;

the positive electrode comprises a positive electrode current collector, a first active material layer and a second active material layer; the second active material layer is positioned between the first active material layer and the positive electrode current collector; the first active material layer comprises a first lithium-containing material, a charge cutoff voltage of the electrochemical device is greater than a potential at which the first lithium-containing material decomposes into lithium and gas, and a gas production rate per unit mass of the first active material layer is greater than a gas production rate per unit mass of the second active material layer.

In some embodiments, the first lithium-containing material comprises at least one of lithium azide, lithium salts of squaric acids, lithium salts of hydrazides, or combinations thereof.

In some embodiments, the first lithium-containing material comprises at least one of Li₂C₃O₃, Li₂C₄O₄, Li₂C₅O₅, Li₂C₆O₆, or LiN₃.

In some embodiments, the second active material layer comprises a second lithium-containing material, the first lithium-containing material and the second lithium-containing material are of a same type of material, and a mass percentage of the first lithium-containing material in the first active material layer is greater than that of the second lithium-containing material in the second active material layer.

In some embodiments, the second active material layer comprises a second lithium-containing material, the first lithium-containing material and the second lithium-containing material are different types of material, and a charge cut-off voltage of the electrochemical device is greater than a potential at which the second lithium-containing material decomposes into lithium and gas.

In some embodiments, the second lithium-containing material comprises at least one of lithium azide, lithium salts of squaric acids, lithium salts of hydrazides, or combinations thereof.

In some embodiments, the second lithium-containing material comprises at least one of Li₂C₃O₃, Li₂C₄O₄, Li₂C₅O₅, Li₂C₆O₆, or LiN₃.

In some embodiments, the first active material layer has a thickness of h1, and the second active material layer has a thickness of h2; wherein h1/(h1+h2) is represented by A that is 10 to 70%.

In some embodiments, the first active material layer comprises a first positive electrode material, the second active material layer comprises a second positive electrode material, and the first positive electrode material comprises at least one of lithium cobaltate, lithium nickelate, lithium manganate, lithium iron phosphate, or lithium cobalt phosphate; and/or the second positive electrode material comprises at least one of lithium cobaltate, lithium nickelate, lithium manganate, lithium iron phosphate, or lithium cobalt phosphate.

An embodiment of the present application further provides an electrochemical device comprising any one of the electrochemical devices proposed in the application.

The electrochemical device provided in an embodiment of the application comprises: a positive electrode, a negative electrode and a separator, and the separator is positioned between the positive electrode and the negative electrode. The positive electrode comprises a positive electrode current collector, a first active material layer and a second active material layer. The second active material layer is positioned between the first active material layer and the positive electrode current collector. The first active material layer comprises a first lithium-containing material, a charge cutoff voltage of the electrochemical device is greater than a potential at which the first lithium-containing material decomposes into lithium and gas, and a gas production rate per unit mass of the first active material layer is greater than a gas production rate per unit mass of the second active material layer. The electrochemical device proposed in some embodiment of the application may help increase the energy density and prevent the positive electrode current collector from separating from the second active material layer.

### DETAILED DESCRIPTION

Embodiments of the present application will be described in more detail as follows. While some embodiments of the present application have been described, it is understood that the present application can be implemented in various forms and should not be construed as being limited to the embodiments set forth herein. Rather, these embodiments are provided for a more thorough and complete understanding of the present application. It should be understood that the embodiments of the present application are used for exemplary purposes, and are not intended to limit the scope of the present application.

Electrochemical devices, such as lithium ion batteries, consume lithium ions during the first cycle of charging and discharging, resulting in a lower initial efficiency. A lithium-supplementing material is added to a positive-electrode slurry, and the slurry is coated on a positive electrode current collector by single layer coating to form a positive electrode active material layer in order to prepare a positive electrode plate. As a result, the initial efficiency of the lithium ion battery comprising the positive electrode plate can be improved to a certain extent. However, the lithium-supplementing material produces gas during formation, which will result in a decrease in the cohesive force between the positive electrode active material layer and the positive electrode current collector.

In some embodiments of the application, an electrochemical device is provided, which comprises a positive electrode, a negative electrode, and a separator between the positive electrode and the negative electrode. In some embodiments, the electrochemical device may be an electrode assembly or a lithium ion battery comprising an electrode assembly and an electrolyte. The lithium ion battery may be a secondary battery (such as a lithium ion secondary battery), a primary battery (such as a lithium primary battery), or the like, but is not limited thereto. The electrode assembly may be a laminated structure formed by stacking a positive electrode, a separator, and a negative electrode in this order, or a wound structure obtained by stacking a positive electrode, a separator, and a negative electrode in this order and then winding them. Among them, the separator is positioned between the positive electrode and the negative electrode to play a role of isolation.

The positive electrode comprises a positive electrode current collector, a first active material layer, and a second active material layer. The second active material layer is positioned between the first active material layer and the positive electrode current collector. The first active material layer comprises a first positive electrode material and a first lithium-containing material, and the second active material layer comprises a second positive electrode material.

The positive electrode current collector is generally a structure or part which may collect current. The positive electrode current collector may be composed of any material suitable for use as a positive electrode current collector of a lithium ion battery in the art. For example, the positive electrode current collector may include but is not limited to metal foil, and more specifically may include but is not limited to nickel foil and aluminum foil. In some embodiments, the positive current collector adopts aluminum foil.

In some embodiments, the first active material layer and the second active material layer may be coated on the positive electrode current collector by double-layer coating. For example, the second active material layer may be coated on the positive electrode current collector, and then the first active material layer may be coated on the side of the second active material layer away from the positive electrode current collector.

The first active material layer and the second active material layer have a first positive electrode material and a second positive electrode material, respectively. The positive electrode material (e.g., the first positive electrode material and/or the second positive electrode material) may be selected from various positive electrode active materials commonly used in the art. For example, as for a lithium ion battery, the positive electrode active material may be selected from lithium cobalt oxides, lithium nickel oxides, lithium manganese oxides, lithium nickel manganese oxides, lithium nickel cobalt manganese oxides, lithium nickel cobalt aluminum oxides, transition metal phosphates, lithium iron phosphates, and the like. However, the present application is not limited to these materials, and other conventionally well-known materials useful for a positive electrode active material for a lithium ion battery may also be used. These positive electrode active materials may be used alone or in combination of two or more. Preferably, the positive active material may be selected from one or more of LiCoO₂, LiNiO₂, LiMnO₂, LiMn₂O₄, LiNi_{1/3}CO_{1/3}Mn_{1/3}O₂(NCM₃₃₃), LiNi_{0.5}Co_{0.2}Mn_{0.3}O₂(NCM₅₂₃), LiNi_{0.6}Co_{0.2}Mn_{0.2}O₂(NCM₆₂₂), LiNi_{0.8}Co_{0.1}Mn_{0.1}O₂(NCM₈₁₁), LiNi_{0.85}Co_{0.15}Al_{0.05}O₂, LiFePO₄, and LiMnPO₄.

Preferably, the first positive electrode material includes at least one of lithium cobaltate, lithium nickelate, lithium manganate, lithium iron phosphate, or lithium cobalt phosphate. Preferably, the second positive electrode material includes at least one of lithium cobaltate, lithium nickelate, lithium manganate, lithium iron phosphate, or lithium cobalt phosphate. Preferably, the first positive electrode material includes at least one of LiCoO₂, LiNiO₂, LiMnO₂, or LiCoPO₄; and/or the second positive electrode material includes at least one of LiCoO₂, LiNiO₂, LiMnO₂, or LiCoPO₄. The first positive electrode material and the second positive electrode material may be the same or different, but not limited thereto.

The first active material layer and the second active material layer have a first lithium-containing material and a second lithium-containing material, respectively. In the present application, the lithium-containing material may also be referred to as a lithium-supplementing material. In some embodiments, the lithium-containing material (e.g., the first lithium-containing material and/or the second lithium-containing material) may include at least one of lithium azide, lithium salts of squaric acids, lithium salts of hydrazides, or combinations thereof.

The first lithium-containing material is added to the first active material layer, so that lithium ions are supplemented in the case that the lithium ions in the first positive electrode material are consumed. Therefore, the initial efficiency and the energy density of the electrochemical device are improved, and the gas production rate (which may be the gas production rate during charging) per unit mass of the first active material layer is greater than a gas production rate per unit mass of the second active material layer. The unit mass may be any preset mass, for example 10 g. Because the gas production rate of the second active material layer is relatively low, the effect of the gas production of the second active material layer on the cohesive force between the second active material layer and the positive electrode current collector is less, thereby preventing the cohesive force from lowering to a certain extent.

In some embodiments, a charge cut-off voltage of the electrochemical device is greater than a potential at which the first lithium-containing material decomposes into lithium and gas (also referred to as a gas production potential of the first lithium-containing material, or a decomposition potential of the first lithium-containing material). For example, the charge cut-off voltage of the electrochemical device may be 4.2V or more, such as 4.2V to 4.5V. The first lithium-containing material has a decomposition potential of 0.3V to 1.0V. Because the first lithium-containing material decomposes and releases lithium and gas at a charge cut-off voltage of the electrochemical device, supplementing lithium ions lost in the first positive electrode material and prevent capacity drop due to the loss of lithium ions. Also, since the first lithium-containing material releases gas at the charge cut-off voltage, pores are generated in the first active material layer, thereby increasing the contact area between the first active material layer and the liquid electrolyte, improving infiltration of the liquid electrolyte to the first positive electrode material, and further achieving a certain gain effect on the rate capability. Moreover, because the first lithium-containing material is located in the first active material layer, and the first active material layer is positioned on the side of the second active material layer away from the positive electrode current collector, the gas production by the first lithium-containing material does not make reduction of the cohesive force between the second active material layer and the positive electrode current collector. Furthermore, because the first active material layer is closer to the surface of the positive electrode, the first active material layer has a higher lithium intercalation degree than the second active material layer, which prolongs the decomposition time, resulting in a more sufficient decomposition.

The charge cut-off voltage of the electrochemical device is related to that of the first positive electrode material and the second positive electrode material. In some embodiments, the charge cut-off voltage of the electrochemical device is the smaller of the charge cut-off potential of the first positive electrode material and of the second positive electrode material.

In some embodiments, the second active material layer comprises a second lithium-containing material in order to supplement lithium to the second positive electrode material. In some embodiments, the gas production rate per unit mass of the second active material layer is less than a gas production rate per unit mass of the first active material layer at a charge cutoff voltage of the electrochemical device. In the present application, the following means may be used to compare the size relationship between the gas production rate per unit mass of the first active material layer and a gas production rate per unit mass of the second active material layer: scraping the same mass of materials from the first active material layer and the second active material layer, respectively; marking them as material 1 and material 2, respectively; dissolving the scraped materials in the same mass of N-methyl pyrrolidone respectively, and stirring them uniformly to obtain slurry 1 and slurry 2 (the same amount of polyvinylidene fluoride may be added to the slurry 1 and the slurry 2 to improve the adhesion of the slurry); and then coating the slurry 1 and the slurry 2 on two same aluminum foils respectively, drying to obtain an electrode plate 1 and an electrode plate 2; using lithium metal as a counter electrode, carrying out charge-discharge test on the electrode plate 1 and the electrode plate 2; measuring the amount of gas production by the electrode plate 1 and the electrode plate 2 under the same charge-discharge conditions; the size relationship between the amount of gas production by the electrode plate 1 and that by the electrode plate 2, and the size relationship between the gas production rate per unit mass of the first active material layer and a gas production rate per unit mass of the second active material layer are the same. The method for testing the gas production rate of the lithium ion battery belongs to a technique well known to those skilled in the art, and will not be further described herein. It is noted that the lithium ion battery used in the test may be a lithium ion battery before formation, or a lithium ion battery after formation, and is not limited herein.

In some embodiments, the first lithium-containing material and the second lithium-containing material are of a same type of material. The mass percentage of the first lithium-containing material in the first active material layer is greater than that of the second lithium-containing material in the second active material layer. In some embodiments, both of the first lithium-containing material and the second lithium-containing material may decompose to release lithium ions and produce gas at the charge-cutoff voltage. A potential at which the second lithium-containing material decomposes into lithium and gas may be referred to as a gas production potential of the second lithium-containing material, or a decomposition potential of the second lithium-containing material. During charging, since the mass percentage of the first lithium-containing material in the first active material layer is greater than that of the second lithium-containing material in the second active material layer, the first active material layer produces more gas increasing the porosity of the first active material layer, which facilitates to improve infiltration of the liquid electrolyte and the rate capability. The second active material layer produces less gas, preventing separation between the second active material layer and the positive electrode current collector by reducing the gas generation of the second active material layer.

In some embodiments, the mass percentage of the first lithium-containing material in the first active material layer and that of the second lithium-containing material in the second active material layer may be calculated as follows: first, taking the same mass of the material of the first active material layer and the material of the second active material layer, marking them as material 1 and material 2; second, carrying out X-ray diffraction on the material 1 and the material 2 to determine the chemical structural formulas of the first lithium-containing material and the second lithium-containing material; third, performing quantitative analysis of element content on the material 1 and the material 2 through X-ray photoelectron spectroscopy, and inversely calculating the mass percentage of the first lithium-containing material in the material 1 and that of the second lithium-containing material in the material 2 according to the quantitative analysis result of the element content in combination with the determined chemical structural formulas of the first lithium-containing material and the second lithium-containing material; wherein the mass percentage of the first lithium-containing material in the material 1 is taken as the mass percentage of the first lithium-containing material in the first active material layer, and the mass percentage of the second lithium-containing material in the material 2 is taken as the mass percentage of the second lithium-containing material in the second active material layer.

In some embodiments, the first lithium-containing material and the second lithium-containing material are different types of materials. For example, the first lithium-containing material is Li₂C₆O₆, and the second lithium-containing material is Li₂C₃O₃. As another example, the first lithium-containing material is Li₂C₄O₄, and the second lithium-containing material is Li₂C₃O₃. In some embodiments, the first lithium-containing material comprises at least one of Li₂C₃O₃, Li₂C₄O₄, Li₂C₅O₅, Li₂C₆O₆, or LiN₃.

In some embodiments, each of the first lithium-containing material and the second lithium-containing material independently comprises at least one of Li₂C₃O₃, Li₂C₄O₄, Li₂C₅O₅, Li₂C₆O₆, or LiN₃. The charge cut-off voltage of the positive electrode is greater than the decomposition potential of these materials, so that the material decomposes to produce gas and release lithium during charging of the electrochemical device, and the released lithium can replenish the lost lithium. The released gas is CO₂ or N₂, which cannot produce side reaction with the Component(s) (such as a liquid electrolyte, etc.) of the electrochemical device so as to prevent the influence on the performance of the electrochemical device. Optionally, the first lithium-containing material and the second lithium-containing material are Li₂C₄O₄.

In some embodiments, the second lithium-containing material comprises at least one of lithium azide, lithium salts of squaric acids, lithium salts of hydrazides, or combinations thereof. For example, the second lithium-containing material comprises at least one of Li₂C₃O₃, Li₂C₄O₄, Li₂C₅O₅, Li₂C₆O₆, or LiN₃.

In some embodiments, the first active material layer has a thickness of h1, and the second active material layer has a thickness of h2; and h1/(h1+h2) is represented by A that is 10 to 70%. The first active material layer contains a first lithium-containing material. If A is less than 10%, the first lithium-containing material may affect the second active material layer during its decomposition. If A is more than 70%, the energy density of the electrochemical device may be affected. Optionally, in the case that A is 30%, the overall performance of the electrochemical device is better.

In some embodiments, the first active material layer and/or the second active material layer may comprise a conductive agent and an adhesive. Exemplary conductive agents include at least one of conductive carbon black, ketjen black, lamellar graphite, graphene, carbon nanotubes, or carbon fibers. For example, polyvinylidene fluoride may be used as the adhesive.

In some embodiments, the negative electrode comprises a negative electrode current collector and a negative electrode active material layer on one or both sides of the negative electrode current collector. The negative current collector can be made of copper foil or other materials.

In some embodiments, the separator comprises at least one of polyethylene, polypropylene, polyvinylidene fluoride, polyethylene terephthalate, polyimide, or aramid. For example, the polyethylene includes at least one selected from high density polyethylene, low density polyethylene, or ultra-high molecular weight polyethylene. Particularly, polyethylene and polypropylene have a good effect on preventing short circuits and enable to improve the stability of the battery through the shutdown effect. In some embodiments, the separator has a thickness within the range of about 5 μm to 500 μm.

In some embodiments, the surface of the separator may further comprise a porous layer provided on at least one surface of the substrate of the separator. The porous layer may be a polymer layer or an inorganic layer, or a layer formed by mixing a polymer and an inorganic substance. For example, the inorganic layer comprises inorganic particles selected from at least one of alumina (Al₂O₃), silica (SiO₂), magnesium oxide (MgO), titanium dioxide (TiO₂), hafnium dioxide (HfO₂), tin oxide (SnO₂), cerium dioxide (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate and an adhesive.

In some embodiments, the pores of the separator have a diameter within the range of about 0.01 μm to 1 μm. The adhesive of the porous layer is selected from at least one of polyvinylidene fluoride, vinylidene fluoride-hexafluoropropylene copolymer, polyamide, polyacrylonitrile, polyacrylate, polyacrylic acid, polyacrylate, sodium carboxymethyl cellulose, polyvinylpyrrolidone, polyvinyl ether, polymethyl methacrylate, polytetrafluoroethylene and polyhexafluoropropylene. The porous layer on the surface of the separator may improve the heat resistance, oxidation resistance and electrolyte infiltration performance thereof and enhance the adhesion between the separator and the electrode plate.

In some embodiments of the application, the electrochemical device is a wound lithium ion battery or a stacked lithium ion battery.

In some embodiments, the electrochemical device may further comprise an electrolyte. The electrolyte may be one or more of a gel electrolyte, a solid electrolyte, and a liquid electrolyte comprising a lithium salt and a non-aqueous solvent. The lithium salt is selected from one or more of LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, LiPF₆ is selected for lithium salt because it can give high ionic conductivity and improve cycle characteristics.

The non-aqueous solvent may be a carbonate compound, a carboxylate compound, an ether compound, other organic solvent, or a combination thereof. The carbonate compound may be a chain carbonate compound, a cyclic carbonate compound, a fluorocarbonate compound, or a combination thereof.

Examples of the chain carbonate compound are diethyl carbonate (DEC), dimethyl carbonate (DMC), dipropyl carbonate (DPC), methyl propyl carbonate (MPC), ethylene propyl carbonate (EPC), methyl ethyl carbonate (MEC) and combinations thereof. Examples of the cyclic carbonate compound are ethylene carbonate (EC), propylene carbonate (PC), butylene carbonate (BC), vinyl ethylene carbonate (VEC), or a combination thereof. Examples of the fluorocarbonate compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

Examples of the carboxylate compound are methyl acetate, ethyl acetate, N-propyl acetate, t-butyl acetate, methyl propionate, ethyl propionate, propyl propionate, γ-butyrolactone, decalactone, valerolactone, mevalonic lactone, caprolactone, methyl formate, or combinations thereof.

Examples of the ether compound are dibutyl ether, tetraglyme, diglyme, 1,2-dimethoxyethane, 1,2-diethoxyethane, ethoxymethoxyethane, 2-methyltetrahydrofuran, tetrahydrofuran, or a combination thereof.

Examples of other organic solvents are dimethylsulfoxide, 1, 2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, and phosphate esters or combinations thereof.

Some embodiments of the present application also provide an electronic device including the above-mentioned electrochemical device. The electronic device of some embodiments of the application is not particularly limited, and can be used in any electronic device known in the prior art. In some embodiments, electronic devices may include, but are not limited to, notebook computers, pen-input computers, mobile computers, e-book players, portable phones, portable fax machines, portable photocopiers, portable printers, headsets, Video recorders, LCD TVs, portable cleaners, portable CD players, MiniDiscs, transceivers, electronic notebooks, calculators, memory cards, portable recorders, radios, backup power supplies, motors, automobiles, motorcycles, assisted bicycles, bicycles, lighting appliance, toys, game consoles, clocks and watches, power tools, flashlights, cameras and large household storage batteries, etc.

Some specific examples and comparative examples are listed below to better explain the present application, in which a lithium ion battery is used as an example. In order to facilitate description of the technical effects of the present application, the difference between the various examples and the comparative example is only that the positive electrode is different. The following examples are only used for schematic illustration, and should not limit the scope of the present application.

### EXAMPLES

### Example 1

(1) Preparation of the Positive Electrode

A second active material layer was coated on the aluminum foil of the positive electrode current collector by double-layer coating, and a first active material layer was coated on one side of the second active material layer away from the positive electrode current collector. The first active material layer was formed by mixing 95.5% LiCoO₂, 1.7% PVDF, 1.6% SP, and 1.2% Li₂C₄O₄ in terms of mass. The second active material layer was formed by mixing 96.7% LiCoO₂, 1.7% PVDF (polyvinylidene fluoride) and 1.6% SP (Super P) in terms of mass. The positive electrode was dried at 85° C., wherein the mass ratio of the first active material layer to the second active material layer is 50%: 50%. The positive electrode was then obtained after cold pressing, cutting, slitting, and drying under the vacuum condition of 85° C. for 4 h.

(2) Preparation of the Negative Electrode

98% artificial graphite, 1.0% SBR (styrene-butadiene rubber) and 1.0% CMC (sodium carboxymethyl cellulose) in terms of mass were mixed to obtain a mixture. Deionized water was added to the mixture, which was stirred by a vacuum mixer to obtain a slurry. The slurry was coated uniformly on the copper foil of the negative electrode current collector. The negative electrode was obtained after drying at 85° C., and then cold pressing, cutting, slitting, and drying under vacuum conditions of 120° C. for 12 h.

(3) Preparation of the Liquid Electrolyte

Ethylene carbonate (EC), ethyl methyl carbonate (EMC), and diethyl carbonate (DEC) were mixed at a volume ratio of 1:1:1 in a glove box under an atmosphere of dry argon to obtain an organic solvent. The fully dried lithium salt LiPF₆ was then dissolved in the mixed organic solvent to prepare the liquid electrolyte with a concentration of 1 mol/L.

(4) Preparation of the Separator

A polyethylene (PE) porous polymer film was used as the separator.

(5) Preparation of the Lithium Ion Battery

The positive electrode, the separator, and the negative electrode was stacked in this order to produce a laminate, in which the separator was allowed to locate between the positive electrode and the negative electrode for isolation. The laminate was then wound to obtain the electrode assembly. The electrode assembly was placed in the outer packaging foil aluminum plastic film after welding the tabs to the assembly. The prepared liquid electrolyte was injected into the dried electrode assembly, and the lithium ion battery (or called the battery) was obtained after the steps of vacuum packaging, standing, forming, shaping, and capacity testing.

Each of examples and comparative examples is based on the steps of Example 1 to change the parameters of the positive electrode preparation, and the parameters are modified specifically as follows.

The difference between Example 2 and Example 1 is that the first active material layer was formed by mixing 95.5% LiNiO₂, 1.7% PVDF, 1.6% SP and 1.2% Li₂C₄O₄ in terms of the mass, while the second active material layer was formed by mixing 96.7% LiNiO₂, 1.7% PVDF and 1.6% SP in terms of the mass.

The difference between Example 3 and Example 1 is that the first active material layer was formed by mixing 95.5% LiMnO₂, 1.7% PVDF, 1.6% SP and 1.2% Li₂C₄O₄ in terms of the mass, while the second active material layer was formed by mixing 96.7% LiMnO₂, 1.7% PVDF and 1.6% SP in terms of the mass.

The difference between Example 4 and Example 1 is that the first active material layer was formed by mixing 95.5% LiCoPO₄, 1.7% PVDF, 1.6% SP and 1.2% Li₂C₄O₄ in terms of the mass, while the second active material layer was formed by mixing 96.7% LiCoPO₄, 1.7% PVDF and 1.6% SP in terms of the mass.

The difference between Example 5 and Example 1 is that the first active material layer was formed by mixing 95.5% mixed material (the mixed material was composed of LiCoO₂ and LiNiO₂ at a mass ratio of 50%:50%), 1.7% PVDF, 1.6% SP and 1.2% Li₂C₄O₄ in terms of the mass, while the second active material layer was formed by mixing 96.7% mixed material (the mixed material was composed of LiCoO₂ and LiNiO₂ at a mass ratio of 50%:50%), 1.7% PVDF and 1.6% SP in terms of the mass.

The difference between Example 6 and Example 1 is that the first active material layer was formed by mixing 95.5% mixed material (the mixed material was composed of LiCoO₂ and LiMnO₂ at a mass ratio of 50%:50%), 1.7% PVDF, 1.6% SP and 1.2% Li₂C₄O₄ in terms of the mass, while the second active material layer was formed by mixing 96.7% mixed material (the mixed material was composed of LiCoO₂ and LiMnO₂ at a mass ratio of 50%:50%), 1.7% PVDF and 1.6% SP in terms of the mass.

The difference between Example 7 and Example 1 is that the first active material layer was formed by mixing 95.5% mixed material (the mixed material was composed of LiCoO₂ and LiCoPO₄ at a mass ratio of 50%:50%), 1.7% PVDF, 1.6% SP and 1.2% Li₂C₄O₄ in terms of the mass, while the second active material layer was formed by mixing 96.7% mixed material (the mixed material was composed of LiCoO₂ and LiCoPO₄ at a mass ratio of 50%:50%), 1.7% PVDF and 1.6% SP in terms of the mass.

The difference between Example 8 and Example 1 is that the first active material layer was formed by mixing 95.5% LiCoO₂, 1.7% PVDF, 1.6% SP and 1.2% Li₂C₃O₃ in terms of the mass, while the second active material layer was formed by mixing 96.7% LiCoO₂, 1.7% PVDF and 1.6% SP in terms of the mass.

The difference between Example 9 and Example 1 is that the first active material layer was formed by mixing 95.5% LiCoO₂, 1.7% PVDF, 1.6% SP and 1.2% Li₂C₅O₅ in terms of the mass, while the second active material layer was formed by mixing 96.7% LiCoO₂, 1.7% PVDF and 1.6% SP in terms of the mass.

The difference between Example 10 and Example 1 is that the first active material layer was formed by mixing 95.5% LiCoO₂, 1.7% PVDF, 1.6% SP and 1.2% Li₂C₆O₆ in terms of the mass, while the second active material layer was formed by mixing 96.7% LiCoO₂, 1.7% PVDF and 1.6% SP in terms of the mass.

The difference between Example 11 and Example 1 is that the first active material layer was formed by mixing 95.5% LiCoO₂, 1.7% PVDF, 1.6% SP and 1.2% LiN₃ in terms of the mass, while the second active material layer was formed by mixing 96.7% LiCoO₂, 1.7% PVDF and 1.6% SP in terms of the mass.

The difference between Example 12 and Example 1 is that the first active material layer was formed by mixing 95.5% LiCoO₂, 1.7% PVDF, 1.6% SP and 1.2% lithium-containing material (the lithium-containing material was composed of Li₂C₃O₃ and Li₂C₄O₄ at a mass ratio of 50%:50%) in terms of the mass, while the second active material layer was formed by mixing 96.7% LiCoO₂, 1.7% PVDF and 1.6% SP in terms of the mass.

The difference between Example 13 and Example 1 is that the first active material layer was formed by mixing 95.5% LiCoO₂, 1.7% PVDF, 1.6% SP and 1.2% lithium-containing material (the lithium-containing material was composed of Li₂C₃O₃ and Li₂C₅O₅ at a mass ratio of 50%:50%) in terms of the mass, while the second active material layer was formed by mixing 96.7% LiCoO₂, 1.7% PVDF and 1.6% SP in terms of the mass.

The difference between Example 14 and Example 1 is that the first active material layer was formed by mixing 95.5% LiCoO₂, 1.7% PVDF, 1.6% SP and 1.2% lithium-containing material (the lithium-containing material was composed of Li₂C₃O₃ and Li₂C₆O₆ at a mass ratio of 50%:50%) in terms of the mass, while the second active material layer was formed by mixing 96.7% LiCoO₂, 1.7% PVDF and 1.6% SP in terms of the mass.

The difference between Example 15 and Example 1 is that the first active material layer was formed by mixing 95.5% LiCoO₂, 1.7% PVDF, 1.6% SP and 1.2% lithium-containing material (the lithium-containing material was composed of Li₂C₃O₃ and LiN₃ at a mass ratio of 50%:50%) in terms of the mass, while the second active material layer was formed by mixing 96.7% LiCoO₂, 1.7% PVDF and 1.6% SP in terms of the mass.

The difference between Example 16 and Example 1 is that the first active material layer was formed by mixing 95.5% mixed material (the mixed material was composed of LiCoO₂ and LiNiO₂ at a mass ratio of 50%:50%), 1.7% PVDF, 1.6% SP and 1.2% lithium-containing material (the lithium-containing material was composed of Li₂C₃O₃ and Li₂C₅O₅ at a mass ratio of 50%:50%) in terms of the mass, while the second active material layer was formed by mixing 96.7% LiCoO₂, 1.7% PVDF and 1.6% SP in terms of the mass.

The difference between Example 17 and Example 1 is that the first active material layer was formed by mixing 95.5% mixed material (the mixed material was composed of LiCoO₂ and LiCoPO₄ at a mass ratio of 50%:50%), 1.7% PVDF, 1.6% SP and 1.2% lithium-containing material (the lithium-containing material was composed of Li₂C₃O₃ and Li₂C₆O₆ at a mass ratio of 50%:50%) in terms of the mass, while the second active material layer was formed by mixing 96.7% LiCoO₂, 1.7% PVDF and 1.6% SP in terms of the mass.

The difference between Example 18 and Example 1 is that the mass ratio of the first active material layer to the second active material layer was 10%:90%.

The difference between Example 19 and Example 1 is that the mass ratio of the first active material layer to the second active material layer was 70%:30%.

The difference between Comparative Example 1 and Example 1 is that a single layer of the positive electrode active material layer was coated on the positive electrode current collector, and the positive electrode active material layer was formed by mixing 95.5% LiCoO₂, 1.7% PVDF, 1.6% SP and 1.2% Li₂C₄O₄ in terms of the mass.

The testing methods of various parameters of the application are described below.

1. Cohesive Force of the Electrode Plates:

After discharging the battery to 3V at a rate of 1C, the battery was disassembled and the entire positive electrode was cut out a rectangular sample with a length of 100 mm and a width of 10 mm with a knife. The aluminum foil and the active material layer on the sample were glued to two clamps, respectively. The movement of the clamp was controlled to peel off the active material layer from the aluminum foil. The maximum tensile force during the peeling process of the electrode plate sample was recorded, and this tensile force was the cohesive force of the electrode plate sample. The peeling force between the active material layer and the aluminum foil was measured by a 180° C. peeling method, the test speed was 300 mm/min, and the test length was 40 mm

2. Decomposition Rate of the Lithium-Supplementing Material:

The actual capacity divided by the designed capacity was the decomposition rate of the lithium-supplementing material. The higher the decomposition rate, the more fully the lithium-supplementing material was decomposed (the lower the residual content). The design capacity was calculated based on the charged capacity per grain of the positive electrode material after the complete delithiation plus the theoretical capacity of the lithium-supplementing material. The test method of the actual capacity was as follows: under the environment of 25° C., both of the comparative example and the examples used 0.2C constant current to charge the battery until the battery voltage was 4.45V, and then used 4.45V constant voltage to charge the battery until the battery current was 0.025C; the battery voltage was then discharged to 3.0V with a current of 0.2C, and the actual capacity of the battery was recorded at this time; the above-mentioned procedure was repeated three times, and the arithmetic average of the actual capacities of the battery recorded three times was calculated as the actual capacity of the battery.

3. The Detection Method of the Residual Material (Qualitative Analysis):

Take the formed battery, discharge the battery to 3.0V with a current of 0.2C, disassemble the battery cell, scrape off the positive active material, dry at 80° C. for 24 h, and detect them by XRD or Raman.

4. 1C Discharge Capacity Retention Rate:

Under the 25° C. environment, both of the comparative example and the examples used 0.2C constant current to charge the battery until the battery voltage was 4.45V, and then charged the battery at 4.45V constant voltage until the charging current was less than 0.025C, which was considered as the battery being fully charged. After fully charged, the battery was discharged with a constant current of 0.2C until the battery voltage was 3.0V, and the actual capacity of the battery was recorded at this time. The above-mentioned procedure was repeated three times, and the arithmetic average of the actual capacities of the battery recorded three times was calculated as the actual capacity of the battery;

Under the 25° C. environment, both of the comparative example and the examples used 0.2C constant current to charge the battery until the battery voltage was 4.45V, and then charged the battery at 4.45V constant voltage until the charging current was less than 0.025C, which was considered as the battery being fully charged. After fully charged, the battery was discharged voltage to 3.0V with a 1C constant current, the 1C discharge capacity of the battery was recorded at this time. The above-mentioned procedure was repeated three times, and the arithmetic average of the 1C discharge capacities of the battery recorded three times was calculated as the 1C discharge capacity. The 1C discharge capacity divided by the actual capacity (0.2C discharge capacity) was the 1C discharge capacity retention rate.

5. 2C Discharge Capacity Retention Rate:

Under the 25° C. environment, both of the comparative example and the examples used 0.2C constant current to charge the battery until the battery voltage was 4.45V, and then charged the battery at 4.45V constant voltage until the charging current was less than 0.025C, which was considered as the battery being fully charged. After fully charged, the battery was discharged with a 2C constant current to a voltage of 3.0V, the 2C discharge capacity of the battery was recorded at this time. The above-mentioned procedure was repeated three times, the arithmetic average of the 2C discharge capacities of the battery recorded three times was calculated as the 2C discharge capacity. The 2C discharge capacity divided by the actual capacity (0.2C discharge capacity) was the 2C discharge capacity retention rate.

6. Porosity Test:

10 pieces of electrode plate samples were taken out, the size was 50 mm×100 mm. 10 pieces of porous substrate were placed in a true porosity tester (Model: AccuPyc II 1340) to measure the porosity of the sample. The real volume Vol of the sample was measured, and then the thickness T of 10 pieces of the samples was measured with a ten-thousandth thickness gauge. The apparent volume Vol0 of the sample was calculated out according to the following equation: Vol0=50×100×T, and the calculated value of the sample was (Vol0-Vol)/Vol0×100%.

The performance test result of the lithium ion batteries in Examples 1 to 19 and Comparative Example 1 was shown in Table 1.

TABLE 1

| | Mass ratio | | | Lithium- | | | | | |
|---|---|---|---|---|---|---|---|---|---|
| | of the first | | | supplementing | Cohesive | Decomposition | | 1C | 2C |
| | active material | | | material | force of the | rate of the | Porosity | discharge | discharge |
| | layer to the | Positive | | (the first lithium- | positive | lithium- | of the | capacity | capacity |
| | second active | electrode | Coating | containing | electrode | supplementing | positive | retention | retention |
| Items | material layer | material | process | material) | plates | material | electrode | rate | rate |
| Com. | / | LiCoO₂ | Single layer | Li₂C₄O₄ | 11.0 | 85% | 24% | 90% | 82% |
| Ex. 1 | | | coating | | | | | | |
| Ex. 1 | 50:50 | LiCoO₂ | Double-layer | Li₂C₄O₄ | 22.1 | 93% | 28% | 94% | 93% |
| | | | coating | | | | | | |
| Ex. 2 | 50:50 | LiNiO₂ | Double-layer | Li₂C₄O₄ | 23.2 | 92% | 27% | 94% | 92% |
| | | | coating | | | | | | |
| Ex. 3 | 50:50 | LiMnO₂ | Double-layer | Li₂C₄O₄ | 24.4 | 95% | 26% | 93% | 92% |
| | | | coating | | | | | | |
| Ex. 4 | 50:50 | LiCoPO₄ | Double-layer | Li₂C₄O₄ | 22.3 | 93% | 26% | 94% | 93% |
| | | | coating | | | | | | |
| Ex. 5 | 50:50 | LiCoO₂ + | Double-layer | Li₂C₄O₄ | 22.3 | 92% | 27% | 95% | 92% |
| | | LiNiO₂ | coating | | | | | | |
| Ex. 6 | 50:50 | LiCoO₂ + | Double-layer | Li₂C₄O₄ | 19.3 | 92% | 27% | 96% | 93% |
| | | LiMnO₂ | coating | | | | | | |
| Ex. 7 | 50:50 | LiCoO₂ + | Double-layer | Li₂C₄O₄ | 19.8 | 93% | 28% | 95% | 92% |
| | | LiCOPO₄ | coating | | | | | | |
| Ex. 8 | 50:50 | LiCoO₂ | Double-layer | Li₂C₃O₃ | 20.7 | 94% | 27% | 94% | 93% |
| | | | coating | | | | | | |
| Ex. 9 | 50:50 | LiCoO₂ | Double-layer | Li₂C₅O₅ | 17.9 | 93% | 29% | 93% | 91% |
| | | | coating | | | | | | |
| Ex. 10 | 50:50 | LiCoO₂ | Double-layer | Li₂C₆O₆ | 19.7 | 95% | 26% | 92% | 91% |
| | | | coating | | | | | | |
| Ex. 11 | 50:50 | LiCoO₂ | Double-layer | LiN₃ | 24.8 | 93% | 27% | 95% | 93% |
| | | | coating | | | | | | |
| Ex. 12 | 50:50 | LiCoO₂ | Double-layer | Li₂C₃O₃ + | 22.1 | 92% | 26% | 96% | 92% |
| | | | coating | Li₂C₄O₄ | | | | | |
| Ex. 13 | 50:50 | LiCoO₂ | Double-layer | Li₂C₃O₃ + | 21.4 | 93% | 27% | 95% | 93% |
| | | | coating | Li₂C₅O₅ | | | | | |
| Ex. 14 | 50:50 | LiCoO₂ | Double-layer | Li₂C₃O₃ + | 24.7 | 94% | 29% | 95% | 92% |
| | | | coating | Li₂C₆O₆ | | | | | |
| Ex. 15 | 50:50 | LiCoO₂ | Double-layer | Li₂C₃O₃ + | 23.2 | 95% | 27% | 94% | 91% |
| | | | coating | LiN₃ | | | | | |
| Ex. 16 | 50:50 | LiCoO₂ + | Double-layer | Li₂C₃O₃ + | 21.7 | 91% | 30% | 93% | 92% |
| | | LiNiO₂ | coating | Li₂C₅O₅ | | | | | |
| Ex. 17 | 50:50 | LiCoO₂ + | Double-layer | Li₂C₃O₃ + | 21.8 | 90% | 28% | 94% | 89% |
| | | LiCoPO₄ | coating | Li₂C₆O₆ | | | | | |
| Ex. 18 | 10:90 | LiCoO₂ | Double-layer | Li₂C₄O₄ | 22.1 | 93% | 26% | 93% | 90% |
| | | | coating | | | | | | |
| Ex. 19 | 70:30 | LiCoO₂ | Double-layer | Li₂C₄O₄ | 22.1 | 93% | 26% | 92% | 90% |
| | | | coating | | | | | | |

Note:
The lithium-supplementing material in Table 1 is the first lithium-containing material.

With reference to Table 1, by comparing Examples 1 to 19 with Comparative Example 1, it can be seen that the cohesive force of the positive electrode plates in Examples 1 to 19 is greater than that in Comparative Example 1, and the decomposition rate of the lithium-supplementing material in Examples 1 to 19 is higher than that in Comparative Example 1. Both of the 1C and 2C discharge capacity retention rates in Examples 1 to 19 are higher than that in Comparative Example 1. This is because the double-layer coating is used in Examples 1 to 19, and the first lithium-containing material as a lithium-supplementing material is added merely to the first active material layer. Since there is no first lithium-containing material in the second active material layer, the second active material layer may not decompose and produce gas, so that the cohesive force between the second active material layer and the positive electrode current collector may not be reduced. Due to the first active material layer being located on the surface of the positive electrode and the potential is higher, the first lithium-containing material in the first active material layer is able to be more fully decomposed. Therefore, the porosity can be increased, and this facilitates to improve infiltration of the liquid electrolyte as well as the rate performance.

By comparing Examples 1 to 7, it can be seen that no matter whether a single positive electrode material or a mixed positive electrode material is used as the positive electrode material, the technical solutions provided in the application can all improve the performance of the lithium ion battery.

By comparing Examples 8 to 11, it can be seen that the technical solutions provided in the application produce the effects for different first lithium-containing materials (the lithium-supplementing materials).

By comparing Examples 12 to 17, it can be seen that the technical solutions provided in the application also produce the effects when the first lithium-containing material is a mixed material.

By comparing Examples 1, 18 and 19, it can be seen that the technical solutions provided in the application produce the effects when the mass ratio of the first active material layer and the second active material layer is within the range of 10:90 to 70:30.

Although the subject matter has been described in a language specific to structural features and/or logical actions of the method, it is understood that the subject matter defined in the appended claims is not necessarily limited to the particular features or actions described above. To the contrary, the particular features and actions described above are merely exemplary forms of implementing the claims.

1. An electrochemical device, comprising:
a positive electrode;
a negative electrode; and
a separator provided between the positive electrode and the negative electrode; wherein
the positive electrode comprises a positive electrode current collector, a first active material layer, and a second active material layer provided between the first active material layer and the positive electrode current collector;
the first active material layer comprises a first lithium-containing material;
a charge cutoff voltage of the electrochemical device is greater than a gas production potential of the first lithium-containing material; and
a gas production rate per unit mass of the first active material layer is greater than a gas production rate per unit mass of the second active material layer.

2. The electrochemical device of claim 1, wherein the first lithium-containing material comprises at least one selected from the group consisting of lithium azide, lithium salts of squaric acids, and lithium salts of hydrazides.

3. The electrochemical device of claim 2, wherein the first lithium-containing material comprises at least one selected from the group consisting of Li₂C₃O₃, Li₂C₄O₄, Li₂C₅O₅, Li₂C₆O₆, and LiN₃.

4. The electrochemical device of claim 1, wherein the second active material layer comprises a second lithium-containing material.

5. The electrochemical device of claim 4, wherein,
a mass percentage of the first lithium-containing material in the first active material layer is greater than a mass percentage of the second lithium-containing material in the second active material layer.

6. The electrochemical device of claim 4, wherein the second lithium-containing material comprises at least one selected from the group consisting of lithium azide, lithium salts of squaric acids, and lithium salts of hydrazides.

7. The electrochemical device of claim 6, wherein the second lithium-containing material comprises at least one selected from the group consisting of Li₂C₃O₃, Li₂C₄O₄, Li₂C₅O₅, Li₂C₆O₆, and LiN₃.

8. The electrochemical device of claim 4, wherein a charge cut-off voltage of the electrochemical device is greater than a gas production potential of the second lithium-containing material.

9. The electrochemical device of claim 1, wherein,
the first active material layer has a thickness of h1; and
the second active material layer has a thickness of h2; and wherein
10%≤h1/(h1+h2)≤70%.

10. The electrochemical device of claim 1, wherein,
the first active material layer comprises a first positive electrode material; and
the second active material layer comprises a second positive electrode material, the first positive electrode material and the second positive electrode material each independently comprising at least one selected from the group consisting of lithium cobaltate, lithium nickelate, lithium manganate, lithium iron phosphate, and lithium cobalt phosphate.

11. An electronic device comprising an electrochemical device, wherein the electrochemical device comprises:
a positive electrode;
a negative electrode; and
a separator provided between the positive electrode and the negative electrode; wherein
the positive electrode comprises a positive electrode current collector, a first active material layer, and a second active material layer provided between the first active material layer and the positive electrode current collector;
the first active material layer comprises a first lithium-containing material;
a charge cutoff voltage of the electrochemical device is greater than a gas production potential of the first lithium-containing material; and
a gas production rate per unit mass of the first active material layer is greater than a gas production rate per unit mass of the second active material layer.

12. The electronic device of claim 11, wherein the first lithium-containing material comprises at least one selected from the group consisting of lithium azide, lithium salts of squaric acids, and lithium salts of hydrazides.

13. The electrochemical device of claim 12, wherein the first lithium-containing material comprises at least one selected from the group consisting of Li₂C₃O₃, Li₂C₄O₄, Li₂C₅O₅, Li₂C₆O₆, and LiN₃.

14. The electronic device of claim 11, wherein the second active material layer comprises a second lithium-containing material.

15. The electronic device of claim 14, wherein,
the first lithium-containing material and the second lithium-containing material are of a same type of material; and
a mass percentage of the first lithium-containing material in the first active material layer is greater than a mass percentage of the second lithium-containing material in the second active material layer.

16. The electronic device of claim 14, wherein the second lithium-containing material comprises at least one selected from the group consisting of lithium azide, lithium salts of squaric acids, and lithium salts of hydrazides.

17. The electronic device of claim 16, wherein the second lithium-containing material comprises at least one selected from the group consisting of Li₂C₃O₃, Li₂C₄O₄, Li₂C₅O₅, Li₂C₆O₆, and LiN₃.

18. The electronic device of claim 14, wherein a charge cut-off voltage of the electronic device is greater than a gas production potential of the second lithium-containing material.

19. The electronic device of claim 11, wherein,
the first active material layer has a thickness of h1; and
the second active material layer has a thickness of h2; and wherein
10%≤h1/(h1+h2)≤70%.

20. The electronic device of claim 11, wherein,
the first active material layer comprises a first positive electrode material; and
the second active material layer comprises a second positive electrode material, the first positive electrode material and the second positive electrode material each independently comprising at least one selected from the group consisting of lithium cobaltate, lithium nickelate, lithium manganate, lithium iron phosphate, and lithium cobalt phosphate.
